(19) United States
(12) Patent Application Publication
(10) Pub. No.: US 2008/0225040 A1
(43) Pub. Date: Sep. 18, 2008

(54) SYSTEM AND METHOD OF TREATING SEMI-TRANSPARENT FEATURES IN THE CONVERSION OF TWO-DIMENSIONAL IMAGES TO THREE-DIMENSIONAL IMAGES

(75) Inventors: Christopher L. Simmons, Calgary (CA); Gregory R. Keech, Calgary (CA); Danny D. Lowe, Calgary (CA)

Correspondence Address: FULBRIGHT & JAWORSKI L.L.P, 2200 ROSS AVENUE, SUITE 2800, DALLAS, TX, 75201-2784, US

(73) Assignee: Conversion Works, Inc., Calgary (CA)

(21) Appl. No.: 11/937,148

(22) Filed: Nov. 8, 2007

Related U.S. Application Data
(60) Provisional application No. 60/894,450, filed on Mar. 12, 2007.

(51) Int. Cl. G06T 15/00

(52) U.S. Cl. 345/419

(57) ABSTRACT

A two dimensional image which has a semitransparent object in the foreground of the image has three contributions to the final color shown in a pixel where the semitransparent object is present. Properties of a semitransparent object and background in the given two dimensional image are processed to determine the contribution of the background color of the image, the foreground color of the object, and the alpha channel of the object. Once these properties are determined, the accurate stereoscopic rendering of the semitransparent object in front of the background allows the two dimensional image to be converted to three dimensions.

### CROSS-REFERENCE TO RELATED APPLICATIONS

This application claims priority benefit of U.S. Provisional Patent Application No. 60/894,450 entitled “TWO-DIMENSIONAL TO THREE-DIMENSIONAL CONVERSION,” filed Mar. 12, 2007, the disclosure of which is hereby incorporated herein by reference.

### TECHNICAL FIELD

The present application is directed towards two-dimensional (2-D) to three-dimensional (3-D) conversion of images. More specifically, the present application is directed to treatment of semitransparent objects in the foreground of a 2-D image during conversion to 3-D.

### BACKGROUND OF THE INVENTION

Humans perceive the world in three spatial dimensions. Unfortunately, most of the images and videos created today are 2-D in nature. If we were able to imbue these images and videos with 3-D information, not only would we increase their functionality, we could dramatically increase our enjoyment of them as well. However, imbuing 2-D images and video with 3-D information often requires completely reconstructing the scene from the original 2-D data depicted. A given set of images can be used to create a model of the observer (camera/viewpoint) together with models of the objects in the scene (to a sufficient level of detail) enabling the generation of realistic alternate perspective images of the scene. A model of a scene thus contains the geometry and associated image data for the objects in the scene as well as the geometry for the cameras used to capture those images.

A number of technologies have been proposed and, in some cases, implemented to perform a conversion of one or several two dimensional images into one or several stereoscopic three dimensional images. The conversion of two dimensional images into three dimensional images involves creating a pair of stereoscopic images for each three dimensional frame. The stereoscopic images can then be presented to a viewer's left and right eyes using a suitable display device. The image information between respective stereoscopic images differ according to the calculated spatial relationships between the objects in the scene and the viewer of the scene. The difference in the image information enables the viewer to perceive the three dimensional effect.

### BRIEF SUMMARY OF THE INVENTION

The present invention is directed to systems and methods that process the properties of one or more semitransparent objects in a given 2-D image. Embodiments of the invention determine the contribution of the background color of the image, the foreground color of the object, and the alpha channel of the object. Once these properties are determined, embodiments of the invention enable accurate stereoscopic rendering of the semitransparent object in front of the background.

The background color, foreground color, and alpha channel represent three variables to be determined. In some example embodiments two of the three unknown variables are recreated or generated using various methods, thereby enabling calculation of the third. Some methods to recreate or generate variables may include spatial fills, temporal fills, artist interpretation, gradients, and the like.

In further example embodiments, one, two or three variables are approximated by an artist. These embodiments may be carried out by providing the artist with a graphical user interface (GUI), which may allow real time manipulations and approximations.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is depicts a 2-D image having a background and a semitransparent object in the foreground.

FIG. 2 depicts an exemplary method for processing at least one pixel in a 2-D image containing a semitransparent object, according to embodiments of the invention.

FIG. 3 depicts an exemplary method for determining properties of a semitransparent object in front of a background of a 2-D image in order to implement a 3-D conversion 300, according to embodiments of the present invention.

FIG. 4 depicts an exemplary layout of a GUI, according to embodiments of the present invention.

FIG. 5 is a depicts an exemplary method involving a sub-pixel, according to embodiments of the invention.

FIG. 6 depicts a block diagram of a computer system which is adapted to use the present invention.

### DETAILED DESCRIPTION OF THE INVENTION

At least one component in a stereoscopic image will necessarily have a different point of view than an original 2-D image. This creates a problem when a semitransparent object is placed in the foreground of the image. From the 2-D perspective the viewer can see a final image which contains properties of both the foreground semitransparent object and the background. Because these properties are combined, it is difficult to obtain a stereo image due to the lack of information concerning the depth of the semitransparent image, distance away from the background, etc. Further, due to the computational intensiveness involved it is seen as not desirable to attempt to determine these separate contributions. Hence, many in the art either simply guess at the solution, or try to remove the semitransparent object so as to not have to deal with the object altogether. The problem is that there are many and possibly infinite solutions.

B*(1−A−)+F*A=C is One possible Calculation

C is the final observed pixel value, B is the background color, F is the foreground color and A is the level of transparency. Thus, from this equation there are infinite solutions. However, these values can all be seen as being between 0 and 1.

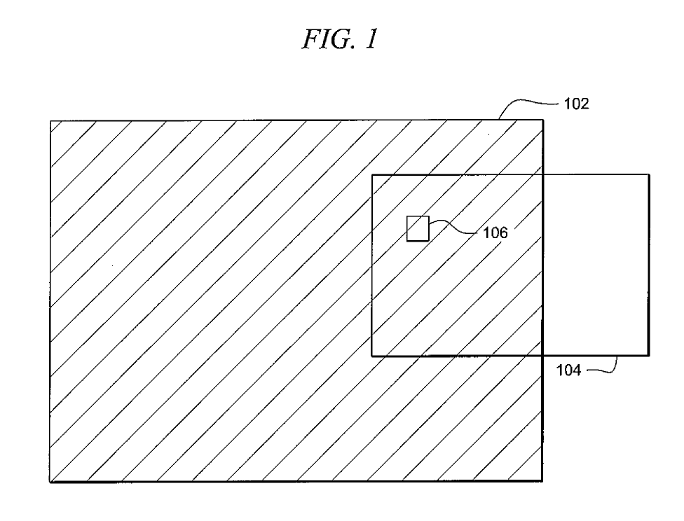

Often, 2-D pictures contain semitransparent objects in the foreground of the image. When viewing semitransparent objects in these 2-D images, an observer sees a final color which can be defined as a function of the properties of the background and the semitransparent object. FIG. 1 shows a 2-D image 100 having a background 102 and a semitransparent object 104 in the foreground. Background 102 and semitransparent object 104 each have a color associated respectively therewith. Semitransparent object 104 also has an associated alpha channel value. In simple terms, the alpha channel is a level of transparency. Normally, the alpha channel value is between zero and one, where one is fully opaque and zero is fully transparent.

Note that the terms semi-transparent and transparent may refer to objects that are in fact at least partially transparent, e.g., a windshield or a piece of glass, but also refer to an object in motion. Such an object has a blur that appears to have a transparency in an image.

2-D image 100 has a pixel 106 located where semitransparent object 104 overlaps background 102. The final color of pixel 106 is characterized by the following:

Cfinal=(Cf*α)+(Cb*1−α) Equation 1

where Cf is the color of the foreground object, Cb is the color of the background object and α is the alpha channel value of the semitransparent object. In the example shown in FIG. 1, the foreground object is object 102, the background object is object 104, and the semitransparent object is object 102. In order to enable an accurate stereoscopic rendering of pixel 106 along with the entire 2-D image 100, the individual contributions of the foreground color, background color, and alpha channel are determined.

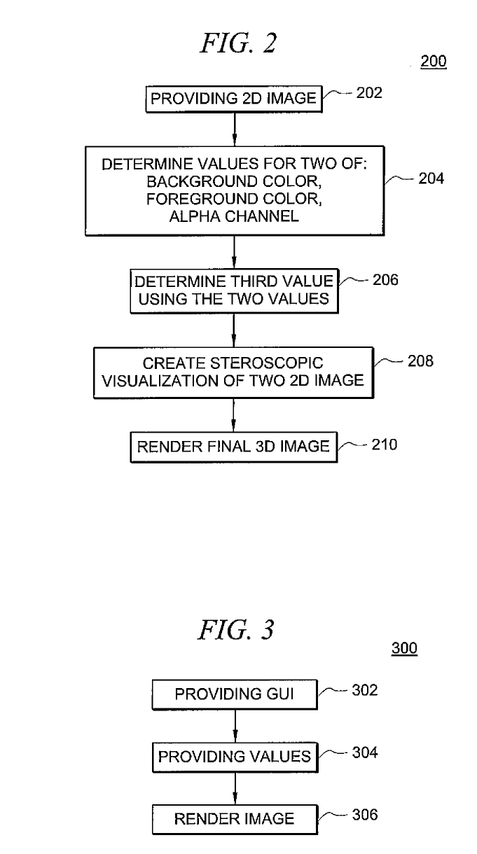

Embodiments of the present invention provide various methods and systems to determine the contributions of the three variables listed above. FIG. 2 illustrates an example method 200 for processing at least one pixel in a 2-D image containing a semitransparent object. The method comprises the steps of providing 202 a 2-D image having one or more pixels with a background color and a semitransparent object in the foreground. As discussed above, the semitransparent object has a foreground color and an alpha channel.

Values for at least two of the three the background color, the foreground color, and the alpha channel variables are then determined at step 204. Various techniques may be implemented to determine these variables including temporal filling, spatial filling, artist recreation or interpretation, and the like. Some example techniques are discussed in detail below.

### Temporal Filling

Temporal filling generally includes searching forward or backward within a frame sequence and using information gained from the search to determine the foreground or background color. There are many ways that such information gained may be used to make these determinations. For example, semitransparent object 104 could be in motion such that when viewing frames that are forward or backward in time, the background area associated with pixel 106 comes out from behind semitransparent object 104. Hence, the desired background color is found when it is able to be viewed in an earlier or later frame without obstruction from semitransparent object 104.

Temporal fills may also be used to determine the foreground color. In some cases, an image may have multiple background which semitransparent object 104 moves across. These backgrounds may never be unobstructed throughout the frame sequence. However, semitransparent object 104 may move across one background with a first color, to another background with a different color. As semitransparent object 104 moves across said backgrounds it will experience a color change, and that color change can be used to determine the actual color of semitransparent object 104. In simple terms, for example, suppose pixel 106 moves with semitransparent object 104. As pixel 106 moves across background 102, the final color observed may be purple, but when pixel 106 moves across a second background (not shown) the final color observed may be orange. In this case, it is apparent that the true color of pixel 106 would be red.

Hence, temporal filling techniques may be implemented in some embodiments of the present invention and are useful in finding either the background color or the foreground color of the semitransparent object. Temporal filing may be accomplished by an artist or automatically. For further information, please see [0003], which is incorporated by reference.

### Spatial Filling

Many spatial filling methods exist in the art and can be useful in the determination of a background color, foreground color, and alpha channel. One such technique uses artist recreation, which is a highly user involved process. Another spatial technique is the erode fill, which is an automatic process. Each technique has benefits in different situations.

To implement an artist recreation, an artist first views the image. When viewing the image, the artist sees the semitransparent object and background. There may be portions in the image where the background is not covered by the semitransparent object. In such cases, an artist could make assumptions about the background. For example, the artist could assume that the background was uniform throughout, and hence, the portion covered by the semitransparent object is the same color as the portion that is not covered. There are numerous beneficial assumptions could be made by an artist regarding both the background and the semitransparent object. In another example, the artist may look at the semitransparent object and see the changes in the final color when the object is over multiple backgrounds. This may give the artist a good approximation of the color of the semitransparent object.

When using an artist recreation technique, some embodiments provide a GUI which will allow the artist to interact with software that assists and implements selections made by the artist. In some embodiments, the software may also display the end results of the manipulations made by the artist, by showing the image at new angle or by showing the stereoscopic pair of images.

An erode fill is designed to be a more automated process. Generally an erode fill implements an algorithm that fills the outermost ring of the semitransparent object by using information in the adjacent pixels that are not covered by the semitransparent object. The outermost ring may be found and outlined via manual rotoscoping, using an automatic selection tool such as a wand, or by manually selecting pixels that pertain to the object. Once the outermost ring is found, adjacent uncovered pixels are blended together to create an approximation of the color for the covered pixel. Erode fill achieves a decent approximation of the background without user intervention. Once the background has been approximated, the foreground color and transparency become far easier to approximate. For further information please see U.S. Provisional Patent Application No. 60/894,450, filed Mar. 12, 2007, which is incorporated by reference. Other spatial filling tools include brushes, clone stamps, and any other commonly used tool in applications, such as Adobe PHOTOSHOP™.

### Alpha Channel Determination Techniques

The above methods used to obtain the background and foreground color may be used to determine alpha channel values. Other methods may also be used to determine alpha channel values. Generally, the alpha channel value is selected by artist interpretation with the assistance various tools. Embodiments of the present invention may use gradients to determine the alpha channel value. For example, one technique may use a focus blur to create a gradient for determining an alpha value. A focus blur can be utilized when an object in an image is at least partially out of focus. Generally, the edge of such an object is at least partially transparent, and the farther out from the edge of the object, the more transparent the object becomes. Hence, the alpha channel from the edge of the object to where the edge of the blur is changing and is gradually getting more and more transparent. Because of this effect, a gradient is generated that represents the change in transparency value. This gradient may be used as a tool to determine the alpha channel at a pixel on a semitransparent object.

A similar method can be used to account for a motion blur. A motion blur occurs when an object is moving across a frame in a frame sequence. Generally the edge of the object appears out of focus and becomes more transparent farther from the edge of the object. Gradients are generated in similar to the focus blur case discussed above. Hence these transparencies are accounted for during image conversion.

Note that, generally, the color of the edge of motion or blur is consistent throughout the transparency. Thus, this provides one of the three parameters. Moreover, the focus blur tends to be uniform around the entire object, whereas a motion blur only occurs in front and behind the object, if the object is moving laterally, e.g., left to right. The top and bottom of the object in motion tends not to have any transparency. The top and bottom are directions orthogonal to the direction of motion.

It is noted that many methods for determining the background color, foreground color, and alpha channel may be known to one skilled in the art. The present invention is not limited to using any particular method for determining these variables. It is also noted that these techniques are useful when dealing with semitransparent objects which take up the entire pixel of interest, as well as with sub-pixel objects. An example of a sub-pixel object may be a strand of hair, or a piece of rope seen from a distance. These objects may only take up a fraction of a pixel to be rendered. Accounting for these objects using the above techniques can give an enhanced effect and a greater realistic feel when viewing the converted image.

Referring again to FIG. 2, once two of the three variables are found, a value for the remaining variable is calculated using the two determined values and given information from the 2-D image at step 206. Using Equation 1, Cfinal is known, as well as two of the variables, thus allowing for calculation of the third variable. With all of the pertinent information found, a stereoscopic visualization of the 2-D image is created using the variable values 208.

Note that there are several different calculations to achieve the final color. However, one calculation may be chosen for rendering, and thus that calculation will be used to calculate the remaining parameter(s). To create the image, the three parameters are to be approximated and/or calculated, such that if the scene were to be rendered from the original camera, the result will be the same as the original 2D image.

In further example embodiments, the one, two, and/or three variables, Cf, Cb, and/or α, are approximated by an artist. These embodiments may be carried out by providing the artist with a graphical user interface (GUI), which may allow real time manipulations and approximations.

While typically, Cfinal is a known parameter, in further example embodiments, the Cfinal may be selected or approximated by an artist, in addition, or instead of the three variables. These embodiments may be carried out by providing the artist with a graphical user interface (GUI), which may allow real time manipulations and approximations.

FIG. 3 illustrates a method for determining properties of a semitransparent object in front of a background of a 2-D image in order to implement a 3-D conversion 300, according to an embodiment of the present invention. The method provides a GUI 302 configured to function to allow a user to manipulate values associated with the semitransparent object and background. In one example embodiment, a user approximates one or more a values for one or more of an alpha channel, background color, and foreground color 304 by interfacing with said graphical user interface. As approximations are made, they are processed and rendered into a 3-D image 306. The GUI may display changes made by the user in real time. This is be done by either showing a new image produced, the stereoscopic pair, or by showing the converted 3-D image. Showing effects of the approximations of the image in real time is beneficial in that it reduces the time necessary for making said approximations.

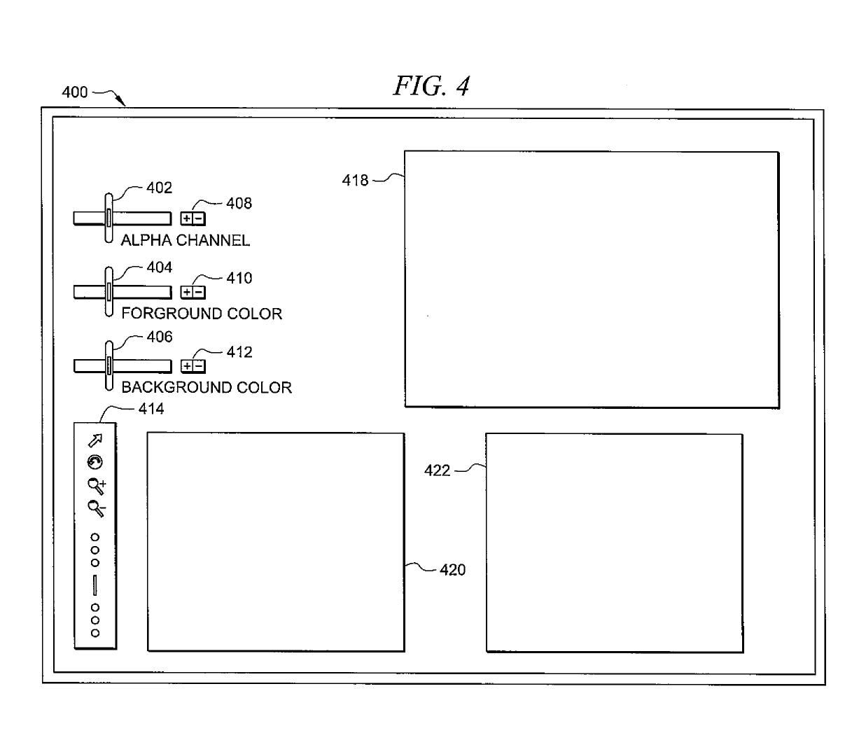

FIG. 4 illustrates an example layout of a GUI 400 for use with some embodiments of the present invention. It is noted that GUI 400 may, in part, be implemented as part of a computer system, such as the one described in reference to FIG. 6 below.

GUI 400 has image adjustment portions 402, 404, 406. Image adjustment portions 402, 404, 406 are shown to have a sliding scale adjustment, however, such adjustment portions may be implemented by any means capable of providing a plurality of adjustments. For example, an alpha channel adjustment may simply be implemented by inserting a number that a user desires to have as the alpha channel. Color adjustments may be made by displaying a color spectrum and selecting an appropriate color on the spectrum. It may also be useful to have the ability to make minor incremental changes to values for fine tuning purposes. Such incremental changes may be carried out by using buttons 408, 410, 412 which are associated with adjustment portions 402 404 406. Note that other types of user interfaces may be used, e.g. a dial or a pallet.

GUI 400 may also contain various image editing tools on toolbar 414. Toolbar 414 provides functionality when working with an image. For example, it may be beneficial to select a portion of an image for manipulation, such as zooming, rotation, cropping, resizing, sharpening, softening, smudging, etc. Various tools may be accessed by selecting them from toolbar 414.

GUI 400 also contains main image display portion 418. Main image display portion 418 presents an image to be edited by a user. GUI 400 preferably gives the user the functionality to focus on selected portions in image display portion 418. For example, a user may want to focus on the edge of a semitransparent object in an image in order to more easily view a portion to make approximations about the background color, foreground color, or alpha channel. Hence, main image display portion 418 is configured to interact with other functionality within the GUI such as toolbar 414, image adjustment portions 402, 404, 406, and buttons 408, 410, 412.

In some embodiments, and as illustrated in FIG. 4, GUI 400 may contain original image display portion 420 and a resulting display portion 422. Original display portion 420 is used to show the appearance of the original image from its initial 2-D perspective. Resulting display portion 422 is configured to show the original image after adjustments are made by the user. In some embodiments, resulting display portion 422 is configured to show the adjusted image from a new stereoscopic perspective which will be used to generate a 3-D image. It is preferable that resulting display portion 422 be updated in real time while the user is making adjustments to the original image, however, this is not required.

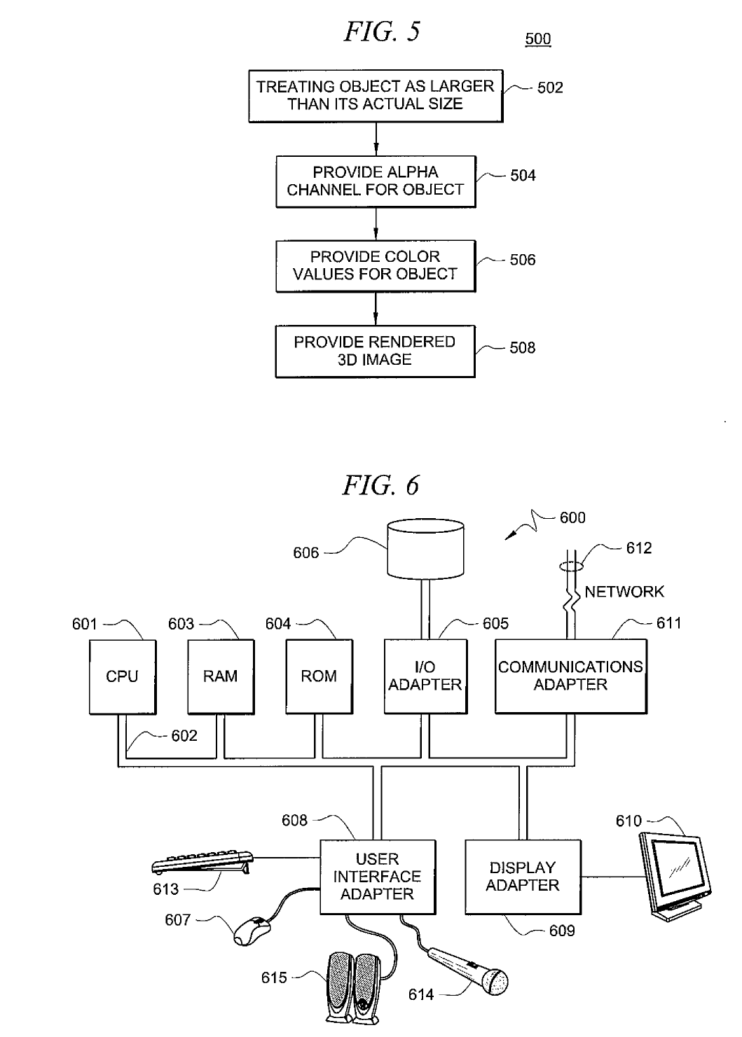

Another embodiment of the present invention provides a simple method to recreate a background when the image has one or more sub pixel objects. One particularly difficult semitransparent object to account for comes when a 2-D image shows hair, such as on a head of a human. It is very complicated to isolate hair in the foreground from a background because multiple hairs intersect, there are portions of the hair that you can or can not see through, there are single strands that are sub-pixel in size, etc. One method 500 of approximation in cases such as this can be shown in FIG. 5. The method comprises treating 502 the entire object as larger in size than it is in actually expressed in the 2-D image. The image is treated larger by upsampling it in order to attain a higher pixel accuracy when attempting to recreated subpixels. By upsampling, the fractional pixel is treated as a whole for the purpose of calculating of the blending parameters. Once the parameters have been calculated and the blending applied, the image can then be downsampled to the original size.

Image processing 504 is then implemented to apply or generate an alpha channel for the entire object. Further processing 506 determines the other two variables. The method will then produce a resulting image 508. The resulting image will generate an effect such that the features of the hair, including highlights and styles, will stand out more than the portions which are normally more transparent. Thus producing a dramatically better effect such that where it seems like an observer can see through the hair at the holes, when in fact they cannot.

In keeping with the hair example, the head of the object is modeled as though it is all one object. That is, instead of attempting to model and/or outline every individual strand of hair, model and outline is performed around only the outer most strands of hair. Then, an alpha channel is created through a number of different techniques, for example, those techniques listed above, to attempt to approximate the alpha channel of the entire head of hair instead of individual strands. This alpha channel will have portions that are very transparent and others that are not. These may or may not match the actual transparency of the 2D image. However, it is often sufficient to appear to a viewer that it does in fact match up.

Note that holes are portions of the hair that a viewer can see through completely. For example, for a head of hair with large curls, a viewer will be able to see through the center of the curls to the background. As another example, another head may have a messy hair (like medusa). There will be places where the hair will be thin or non-existent, allowing a viewer to see through to the background. These portions are referred to as holes, because the exterior hair strands can be modeled and outlined as one object instead of hundreds of thousands of objects.

Further, this method has the potential to increase computing or conversion efficiency because when sub pixel objects, such as hair on a human head, are present in a 2-D image, there can be potentially hundreds of individual semitransparent objects that may have to be taken into account during conversion. It is noted that while this method does not give the most accurate color and alpha values, it creates an aesthetically good effect, while being relatively easy to implement. Note that other sub-pixel objects may be string, rope, wires, branches, leaves, grass, threads of clothes, needles, and a distant object.

Many of the methods, techniques, and processes described herein may be implemented in a fully automated, semi-automated, or manual fashion. Generally there are speed advantages to automation and quality advantaged when allowing a user or artist to control the process. Semi-automated techniques may have an artist make initial approximations and then have a computer run an optimization/error minimization process. Such a process may be configured to take approximations for background color, foreground color, and alpha values and calculate a final result. Those results can then be compared with the original values from the initial 2-D image.

Note that many of the functions described herein may be implemented in hardware, software, and/or firmware, and/or any combination thereof. When implemented in software, the elements of the present invention are essentially the code segments to perform the necessary tasks. The program or code segments can be stored in a processor readable medium or transmitted by a computer data signal. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, etc. The computer data signal may include any signal that can propagate over a transmission medium such as electronic network channels, optical fibers, etc. The code segments may be downloaded via computer networks such as the Internet, Intranet, etc.

FIG. 6 illustrates computer system 600 adapted to use the present invention. Central processing unit (CPU) 601 is coupled to system bus 602. The CPU 601 may be any general purpose CPU, such as an Intel Pentium processor. However, the present invention is not restricted by the architecture of CPU 601 as long as CPU 601 supports the inventive operations as described herein. Bus 602 is coupled to random access memory (RAM) 603, which may be SRAM, DRAM, or SDRAM. ROM 604 is also coupled to bus 602, which may be PROM, EPROM, or EEPROM. RAM 603 and ROM 604 hold user and system data and programs as is well known in the art.

Bus 602 is also coupled to input/output (I/O) controller card 605, communications adapter card 611, user interface card 608, and display card 609. The I/O adapter card 605 connects to storage devices 606, such as one or more of a hard drive, a CD drive, a floppy disk drive, a tape drive, to the computer system. The I/O adapter 605 is also connected to printer 614, which would allow the system to print paper copies of information such as document, photographs, articles, etc. Note that the printer may a printer (e.g. ink jet, laser, etc.), a fax machine, or a copier machine. Communications card 611 is adapted to couple the computer system 600 to a network 612, which may be one or more of a telephone network, a local (LAN) and/or a wide-area (WAN) network, an Ethernet network, and/or the Internet network. User interface card 608 couples user input devices, such as keyboard 613, pointing device 607, and microphone 616, to the computer system 600. User interface card 608 also provides sound output to a user via speaker(s) 615. The display card 609 is driven by CPU 601 to control the display on display device 610. Display device 610 may be used to display aspects as described with the GUI while a user interacts with keyboard 613 and pointing device 607. Display device 610 may also function as a touch screen device giving the user a direct interface on the screen.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for processing of 2-D image data, said method comprising:
providing image data that is formed from an interaction of a foreground object that is semitransparent, and a background object, wherein the foreground object has an associated foreground color value and an alpha channel value, and the background object has an associated background color value;
determining values for at least two of said background color value, said foreground color value, and said alpha channel value;
calculating a value for the remaining of said background color value, said foreground color value, and said alpha channel value using the two determined values;
creating a stereoscopic visualization of the 2-D image using the determined values and the calculated value; and
rendering a final 3-D image using said stereoscopic visualization.

2. The method of claim 1 wherein the step of determining values comprises:
implementing a spatial fill technique to determine at least one of said values.

3. The method of claim 1 wherein the step of determining values comprises:
using gradients to determine at least one of said values.

4. The method of claim 1 wherein the step of determining values comprises:
implementing a temporal fill technique to determine at least one of said values.

5. The method of claim 1 wherein the step of determining values comprises:
approximating, by an artist, a value of at least one of said variables.

6. The method of claim 5 further comprising:
providing a graphical user interface (GUI) to the artist,
wherein said GUI facilitates and implements changes made by the artist and displays the resulting changes.

7. The method of claim 1, wherein the image data is a pixel.

8. The method of claim 1, wherein the semitransparent object is an object in motion.

9. The method of claim 1 wherein the foreground object is a sub-pixel object and the proportion of area taken up by said sub-pixel object with respect to the pixel is accounted for during the creating.

10. A method for determining properties of a semitransparent object in front of a background in a 2-D image in order to implement a 3-D conversion, said method comprising:
providing a graphical user interface configured to function to allow a user to manipulate values associated with said semitransparent object and said background;
approximating, by a user, for at least one of an alpha channel value, a background color value, and a foreground color value by interfacing with said graphical user interface; and
processing said approximations to produce a 3-D image.

11. The method of claim 8 further comprising:
minimizing error between the approximated values using information from the original 2-D image.

12. The method of claim 8 further comprising:
displaying in real time, a resulting view of said 2-D image reflecting said user approximations.

13. The method of claim 10 wherein said resulting view is viewed by the user as an alternate perspective view for a stereoscopic pair.

14. A method of treating semitransparent objects in a 2-D image for in a 2-D to 3-D conversion, said method comprising:
treating the entire semitransparent object as larger than its rendering in the 2-D image;
determining an alpha channel value for the semitransparent object;
applying said alpha channel to the semitransparent object;
determining a color value for the semitransparent object;
creating a stereoscopic visualization of the 2-D image using the variable values; and
rendering a final 3-D image using said stereoscopic visualization.

15. The method of claim 14 wherein the semitransparent object is an area containing hair, whereby the rendered image will have an effect such that the features of the hair will stand out more than the portions which are normally more transparent.

16. The method of claim 14 wherein the semitransparent object is one of string, rope, wires, branches, leaves, grass, threads of clothes, needles, and a distant object.

17. The method of claim 14 wherein at least one hair is a sub-pixel object.

18. A computer program product having a computer readable medium having computer program logic recorded thereon for processing a 2-D image into a 3-D image, the computer program product comprising:
code for allowing a user to determine at least one of an alpha channel value of a semitransparent object in the 2-D image, a background color value in the 2-D image, and a foreground color value of the semitransparent object by interfacing with said graphical user interface;
code for calculating a value for the remaining of said background color value, said foreground color value, and said alpha channel value using the determined values; and
code for processing the determined values and the calculated value to produce the 3-D image.

19. The computer program product of claim 18, further comprising:
code for implementing one or a spatial fill technique and a temporal fill technique to determine at least one of said values.

20. The computer program product of claim 18, further comprising:
code for approximating, by an artist, a value of at least one of said values.

21. The computer program produce of claim 19, further comprising:
code for providing a graphical user interface (GUI) configured to function to allow a user to manipulate values associated with the semitransparent object and a background of the 2-D image; and
code for display the 3-D image using the GUI.
